(19) United States
(12) Patent Application Publication
(10) Pub. No.: US 2025/0042048 A1
(43) Pub. Date: Feb. 6, 2025

(54) Carbide Blade for Utility Knife

(71) Applicant: Milwaukee Electric Tool Corporation, Brookfield, WI (US)

(72) Inventors: Choon Yen Kong, Newmarket (GB); Pavels Sevcenko, Newmarket (GB); Nathan M. Moore, Pewaukee, WI (US); Mark E. Kleeman, Milwaukee, WI (US)

(21) Appl. No.: 18/750,402

(22) Filed: Jun. 21, 2024

Related U.S. Application Data
(60) Provisional application No. 63/517,674, filed on Aug. 4, 2023.

(51) Int. Cl. B26B 9/00; B22F 5/00

(52) U.S. Cl. CPC B26B 9/00; B22F 5/006; B22F 2005/001

(57) ABSTRACT

Embodiments of the disclosure relate to a blade that includes a blade body having a first material having a primary elemental constituent. A barrier layer is disposed on the blade body, and the barrier layer includes a second material that does not contain the primary elemental constituent of the first material. A carbide layer is disposed on the barrier layer, and the carbide layer includes a carbide material and a binder material. The carbide layer forms a cutting edge of the blade. The barrier layer provides continuous separation between the blade body and the carbide layer.

### CROSS-REFERENCE TO RELATED PATENT APPLICATIONS

The present application claims the benefit of and priority to U.S. Provisional Application No. 63/517,674, filed on Aug. 4, 2023, which is incorporated herein by reference in its entirety.

### BACKGROUND OF THE INVENTION

The present disclosure relates to a blade for a utility knife and, in particular, to a blade having a carbide cutting edge.

### SUMMARY OF THE INVENTION

In a first aspect, embodiments of the present disclosure relate to a blade. The blade comprises a blade body comprising a first material having a primary elemental constituent. The blade further comprises a barrier layer disposed on the blade body, and the barrier layer comprises a second material that does not contain the primary elemental constituent of the first material. A carbide layer is disposed on the barrier layer, and the carbide layer comprises a carbide material and a binder material. The carbide layer forms a cutting edge of the blade. The barrier layer provides continuous separation between the blade body and the carbide layer.

In a second aspect, embodiments of the present disclosure relate to the blade according to the first aspect in which the carbide material comprises at least one of tungsten carbide, chromium carbide, titanium carbide, tantalum carbide, or niobium carbide.

In a third aspect, embodiments of the present disclosure relate to the blade according to the first aspect or the second aspect in which the binder material comprises at least one of nickel, cobalt, chromium, iron, or molybdenum.

In a fourth aspect, embodiments of the present disclosure relate to the blade according to any of the first aspect to the third aspect in which the carbide layer comprises from 25 wt % to 95 wt % of carbide material and from 5 wt % to 75 wt % of binder material.

In a fifth aspect, embodiments of the present disclosure relate to the blade according to any of the first aspect to the fourth aspect in which the first material comprises a steel alloy and wherein the barrier layer comprises a cobalt alloy.

In a sixth aspect, embodiments of the present disclosure relate to the blade according to any of the first aspect to the fifth aspect in which the carbide layer is harder than the blade body and the blade body is harder than the barrier layer.

In a seventh aspect, embodiments of the present disclosure relate to the blade according to any of the first aspect to the sixth aspect in which the carbide layer has a hardness in a range from 800 HV to 1500 HV.

In an eighth aspect, embodiments of the present disclosure relate to the blade according to any of the first aspect to the seventh aspect in which the carbide layer comprises about 16.5 wt % tungsten, about 15.5 wt % chromium, about 4 wt % silicon, about 3.5 wt % iron, about 2.9 wt % boron, about 2 wt % carbon, and a balance of nickel.

In a ninth aspect, embodiments of the present disclosure relate to the blade according to any of the first aspect to the eighth aspect in which the blade comprises a first edge, a second edge, a first surface, and a second surface. The cutting edge is the first edge, and the second edge is on an opposite side of the blade from the first edge. The first surface and the second surface each extend from the first edge to the second edge, and the second surface is opposite to the first surface. The first surface and the second surface define a maximum thickness of the blade in which the maximum thickness is 2 mm or less.

In a tenth aspect, embodiments of the present disclosure relate to the blade according to the ninth aspect in which the second edge comprises one or more notches configured to engage a blade holder of a utility knife.

In an eleventh aspect, embodiments of the present disclosure relate to the blade according to any of the first aspect to the tenth aspect in which the carbide layer has a thickness in a range from 0.4 mm to 1 mm.

In a twelfth aspect, embodiments of the present disclosure relate to a method of forming a blade. In the method, an edge surface of a strip of a blade body is heated. A first powder is applied onto the heated edge surface of the strip to form a barrier layer. The barrier layer is heated. A second powder is applied onto the heated barrier layer to form a carbide layer. The barrier layer continuously separates the carbide layer from the strip of the blade body. The blade body comprises a first material having a primary elemental constituent and the barrier layer comprises a second material that does not contain the primary elemental constituent of the first material.

In a thirteenth aspect, embodiments of the present disclosure relate to the method according to the twelfth aspect in which applying the second powder comprises applying first particles of one or more metals or alloys and applying second particles of carbon. Further, in the method, carbide particles are precipitated in a melt pool formed during heating of the barrier layer.

In a fourteenth aspect, embodiments of the present disclosure relate to the method according to the twelfth aspect in which applying the second powder comprises applying a combination of carbide particles and binder particles.

In a fifteenth aspect, embodiments of the present disclosure relate to the method according to any of the twelfth aspect to the fourteenth aspect in which applying the second powder comprises applying the second powder in a plurality of layers each having a thickness in a range from 0.1 mm to 0.2 mm to provide a carbide layer with a total thickness in a range from 0.4 mm to 1 mm.

In a sixteenth aspect, embodiments of the present disclosure relate to the method according to any of the twelfth aspect to the fifteenth aspect in which the method further comprises the step of heat treating the strip of the blade body after applying the second powder.

In a seventeenth aspect, embodiments of the present disclosure relate to the method according to the sixteenth aspect in which heat treating comprises heating the strip at a rate in a range from 100° C./min to 130° C./min to a temperature in the range of 1050° C. to 1115° C., holding at the temperature for a time in a range from 1 minute to 10 minutes, and air quenching to room temperature.

In an eighteenth aspect, embodiments of the present disclosure relate to the method according to the sixteenth aspect or the seventeenth aspect in which after heat treating the carbide layer has a hardness in a range from 800 HV to 1500 HV.

In a nineteenth aspect, embodiments of the present disclosure relate to the method according to any of the twelfth aspect to the eighteenth aspect in which the method further comprises the step of grinding the carbide layer to form a cutting edge of the blade.

In a twentieth aspect, embodiments of the present disclosure relate to the method according to any of the twelfth aspect to the nineteenth aspect in which, during the heating of the barrier layer and applying of the second powder, the first material of the blade body is not able to diffuse into the carbide layer. Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 depicts a utility knife including a blade having a carbide cutting edge, according to an embodiment of the present disclosure;

FIG. 2 depicts a blade for a utility knife having a carbide cutting edge, according to an embodiment of the present disclosure;

FIG. 3 depicts cross-sectional view of a carbide cutting edge region of the blade, according to an embodiment of the present disclosure;

FIG. 4 depicts a deposition setup for applying powdered material for the barrier layer and carbide layer to a strip of blade body, according to an embodiment of the present disclosure;

FIG. 5 depicts barrier material applied to an edge of the blade body, according to an embodiment of the present disclosure;

FIG. 6 is a micrograph of the blade body having the barrier layer and carbide layer deposited thereon, according to an embodiment of the present disclosure; and

FIG. 7 is a flow diagram of a method of manufacturing the blade having a carbide edge, according to an embodiment of the present disclosure.

### DETAILED DESCRIPTION

Various aspects of the disclosure relate to embodiments of a blade having a carbide cutting edge with a barrier layer disposed between the blade body and the carbide layer. According to embodiments of the present disclosure, the blade is configured to be used with a utility knife.

As will be discussed more fully below, the barrier layer of the blade continuously separates the blade body from the carbide layer. The barrier layer is comprised of a material that is different from the material of the blade body, in particular a material lacking the primary constituent of the blade body. In this way, elements from the blade body are prevented from diffusing into the carbide layer. In conventional blades in which the carbide is in contact with the blade body, elements from the blade body may diffuse into the carbide layer during formation of the blade, which may cause the formation of brittle phases that lead to premature failure of the blade.

These and other aspects and advantages will be described below in relation to exemplary embodiments and in relation to the accompanying figures, and such discussion is provided by way of illustration and not limitation.

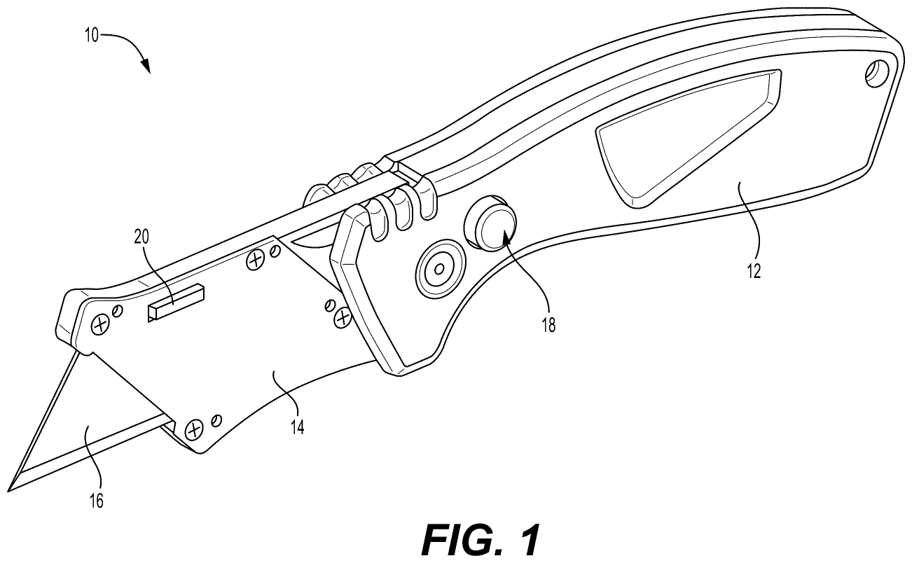

FIG. 1 depicts a utility knife 10 according to an exemplary embodiment. The utility knife includes a handle 12, a blade holder 14, and a blade 16. In one or more embodiments, the blade holder 14 is pivotally coupled to the handle 12. In particular, the utility knife 10 has a folded configuration in which the blade holder 14 and blade 16 rotate into the handle 12 so that the handle 12 acts as a guard for the blade 16. In an unfolded configuration, the blade holder 14 is generally axially aligned with the handle 12, and the blade 16 is exposed for cutting. FIG. 1 depicts the utility knife 10 in the unfolded configuration. To retain the blade holder 14 in the unfolded configuration, the utility knife 10 may include a locking mechanism 18 that prevents the blade holder 14 from folding from the unfolded configuration. For example, a user must press the locking mechanism 18 to allow for folding of the utility knife 10 from the unfolded configuration to the folded configuration.

In one or more embodiments, the blade 16 is inserted into the blade holder 14. In one or more embodiments, the blade 16 is reversibly inserted into the blade holder 14. In this way, a blade 16 can be removed and replaced as needed when the cutting edge wears out. In one or more embodiments, the blade holder 14 includes a release button 20 that allows the blade 16 to be removed from the blade holder 14.

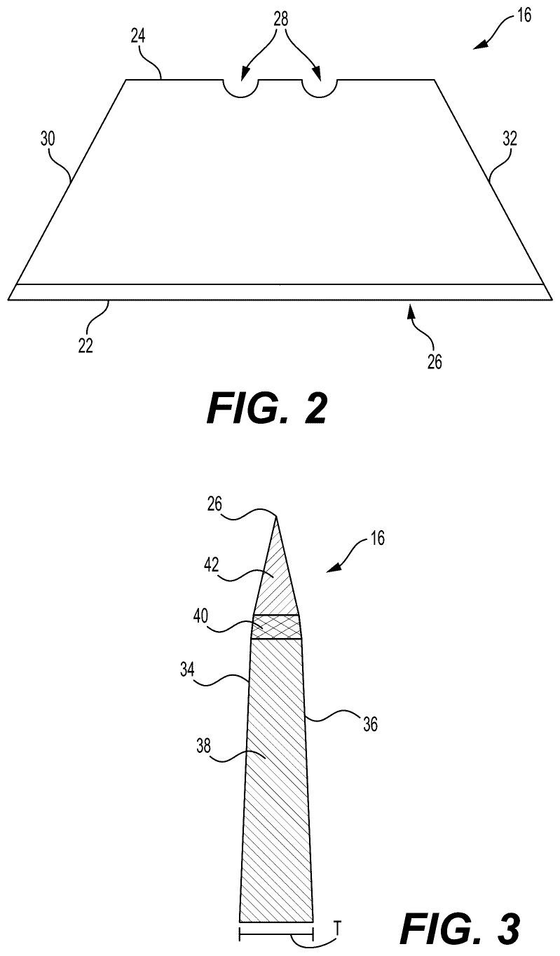

FIG. 2 depicts an embodiment of a blade 16 according to the present disclosure. As can be seen, the blade 16 has a first edge 22 and a second edge 24 on an opposite side of the blade 16 from the first edge 22. In one or more embodiments, the first edge 22 and the second edge 24 are substantially parallel to each other. In one or more embodiments, the first edge 22 and the second edge 24 each have a length of 100 mm or less, in particular in a range of 50 mm to 75 mm, and most particularly about 60 mm+5 mm. Further, in one or more embodiments, the first edge 22 and the second edge 24 have different lengths with the first edge 22 being longer than the second edge 24. In such embodiments, the first edge 22 may have a length in the range of 50 mm to 75 mm (in particular 60 mm+5 mm), and the second edge 24 may have a length in the range of 20 mm to 50 mm (in particular 32 mm+5 mm). In one or more embodiments, the first edge 22 is spaced a distance in a range from 10 mm to 30 mm (in particular 19 mm+5 mm) from the second edge 24, the distance being measured perpendicular to both the first edge 22 and the second edge 24.

In one or more embodiments, the first edge 22 is a cutting edge 26 of the blade 16, and in one or more embodiments, the second edge 24 is configured to engage the blade holder 14. In such embodiments, the second edge 24 may include one or more notches 28 configured to engage blade catches (not shown) in the blade holder 14 to retain the blade 16 in the blade holder 14. In one or more embodiments, the release button 20 causes the blade catches to disengage the notches 28, allowing the blade 16 to be removed from the blade holder 14.

The blade 16 includes a first side edge 30 and a second side edge 32. As shown in the embodiment of FIG. 2, the first edge 22 is longer than the second edge 24, and each of the first side edge 30 and the second side edge 32 form an acute angle with respect to the first edge 22 and an obtuse angle with respect to the second edge 24. In such embodiments, the blade 16 may be define a trapezoidal shape. However, in one or more other embodiments, the blade 16 may define a rectangular shape or a rhomboid shape, among other possibilities. Further, in one or more embodiments, both the first edge 22 and the second edge 24 may be cutting edges 26.

FIG. 3 depicts a cross-sectional view of the cutting edge 26 of the blade 16. The blade 16 includes a first surface 34 and a second surface 36. The second surface 36 is opposite to the first surface 34. In one or more embodiments, the first surface 34 and the second surface 36 define a maximum thickness T of the blade 16. In one or more embodiments, the maximum thickness is 2 mm or less, in particular in a range from 0.3 mm to 1 mm, and most particularly 0.6 mm+0.1 mm.

As can be seen in FIG. 3, the cutting edge 26 generally includes three regions: a blade body 38, a barrier layer 40, and a carbide layer 42. The blade body 38 makes up the most substantial part of the blade 16. In one or more embodiments, the blade body 38 extends from the second edge 24 at least 90%, at least 92%, at least 94%, at least 96%, or up to 98% of the distance between the second edge 24 and the first edge 22. The barrier layer 40 is disposed between the blade body 38 and the carbide layer 42, continuously separating the blade body 38 from the carbide layer 42. As will be discussed more fully below, the barrier layer 40 prevents diffusion of elements from the blade body 38 into the carbide layer 42, which may make the carbide layer 42 too brittle.

In one or more embodiments, the blade body 38 is formed of a steel alloy.

In one or more embodiments, the carbide layer 42 includes one or more carbide materials in a binder material. In one or more embodiments, the carbide materials include at least one of tungsten carbide (WC), chromium carbide (e.g., Cr₃C₂), titanium carbide (TIC), tantalum carbide (TaC), or niobium carbide (NbC), among other possibilities. In one or more embodiments, the binder material includes at least one of nickel, cobalt, chromium, iron, or molybdenum, among other possibilities. In one or more embodiments, the carbide layer 42 includes the carbide material in an amount in a range from 25 wt % to 95 wt %, in particular from 30 wt % to 90 wt %. In one or more embodiments, the carbide layer 42 includes binder material in an amount in a range from 5 wt % to 75 wt %, in particular from 10 wt % to 70 wt %. In one or more particular embodiments, the carbide layer 42 comprises about 16.5 wt % tungsten, about 15.5 wt % chromium, about 4 wt % silicon, about 3.5 wt % iron, about 2.9 wt % boron, about 2 wt % carbon, and the balance of nickel.

In one or more embodiments, the barrier layer 40 comprises a metal or alloy dissimilar from the material of the blade body 38 to prevent diffusion of the material of the blade body 38 into the carbide layer 42. In particular, the barrier layer 40 does not include the primary elemental constituent of the metal or alloy of the blade body 38. For example, if the blade body 38 is made from a steel alloy, then the barrier layer 40 does not include iron. In one or more embodiments, the barrier layer 40 comprises a cobalt-chromium alloy, in particular comprising about 28 wt % to about 29 wt % chromium, about 5 wt % to about 6 wt % molybdenum, and the balance cobalt.

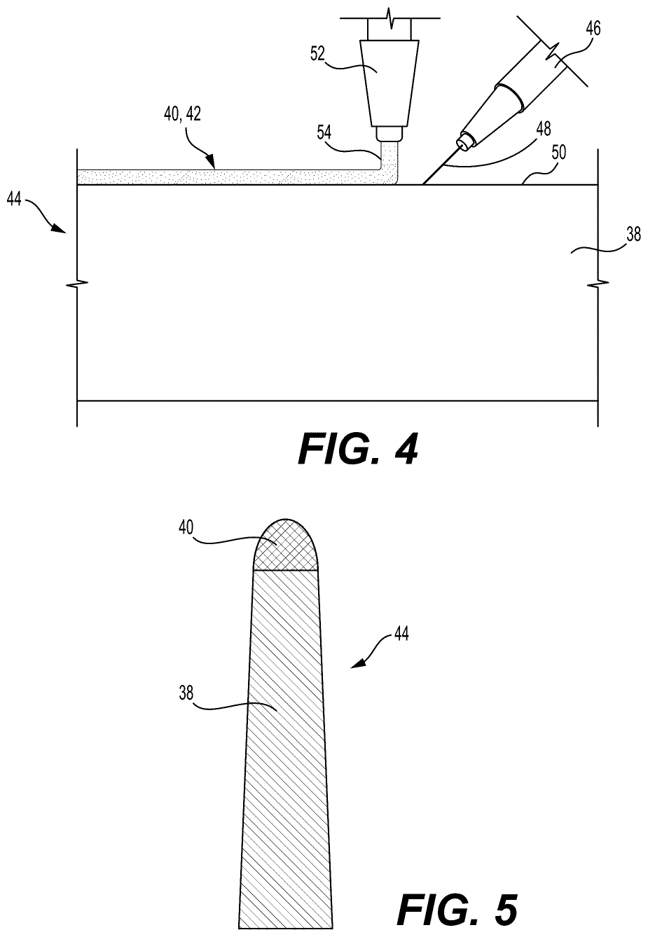

FIG. 4 depicts an embodiment of a setup for depositing the barrier layer 40 and the carbide layer 42 on a strip 44 of material for the blade body 38. As shown in FIG. 4, a laser 46 emits a beam 48 on an edge surface 50 of the strip 44, which melts the strip 44 in the region of the edge surface 50. A nozzle 52 directs powder 54 of the material of the barrier layer 40 onto the molten edge surface 50 of the strip 44, causing the powder 54 to melt and fuse to the blade strip 44. During deposition, the strip 44 and the laser 46 and nozzle 52 move relative to each other. In one or more embodiments, the laser 46 and the nozzle 52 are stationary, and the strip 44 moves past the laser 46 and nozzle 52. In one or more other embodiments, the laser 46 and the nozzle 52 move across a stationary strip 44.

In one or more embodiments, the powder 54 comprises particles of the alloy or the metals that make up the barrier layer 40. In one or more embodiments, the powder 54 comprises particles having an average size in a range from 15 microns to 45 microns. In one or more embodiments, the particles of the powder 54 have a generally spherical shape. In one or more embodiments, the barrier layer 40 is deposited having a thickness of about 0.1 mm. The final barrier layer 40 may be made up of one or multiple layers of the material of barrier layer 40 deposited by one or multiple passes by the laser 46 and nozzle 52 over the strip 44.

FIG. 5 depicts a cross-sectional view of a strip 44 having the barrier layer 40 deposited thereon. As can be seen, the deposited barrier layer 40 forms a parabolic surface on the edge surface 50 of the strip 44. In one or more embodiments, the parabolic surface may be substantially smooth, but in one or more other embodiments, the parabolic surface may have a rough texture, like a weld seam.

After the barrier layer 40 is formed on the strip 44, the carbide layer 42 is deposited. The carbide layer 42 is deposited using substantially the same setup as the shown in FIG. 4. In particular, the laser 46 is directed over the barrier layer 40 to melt at least a portion of the barrier layer 40, and powder 54 of the carbide layer 42 is directed onto the molten barrier layer 40 by the nozzle 52. While reference is made to FIG. 4, the laser and nozzle used to apply the carbide layer 42 is not necessarily the same laser and nozzle used to apply the barrier layer 40.

In one or more embodiments, the powder 54 of the carbide layer 42 includes metal alloy powder and carbon powder. In such embodiments, carbides (such as tungsten carbide and/or chromium carbide) precipitate in the melt pool and solidify in the metal matrix during cooling. In one or more such embodiments, the metal alloy powder may comprise, for example, nickel, tungsten, chromium, silicon, iron, and boron. The metal alloy particles may be generally spherical and have a size of up to 120 microns, in particular in a range of from 11 microns to 53 microns. The carbon powder may have a flaky morphology with an average particle size of up to 120 microns, in particular in a range of 7 microns to 11 microns.

In one or more other embodiments, the powder 52 includes carbide particles and binder particles. In one or more embodiments, the carbide particles comprise tungsten carbide and the binder particles comprise cobalt and/or nickel.

In one or more embodiments, the carbide layer 42 is deposited in multiple layers. Each layer has a thickness in a range from 0.1 mm to 0.2 mm, in particular about 0.15 mm. In one or more such embodiments, the carbide layer 42 may include, for example, from two to five layers. In one or more embodiments, the carbide layer 42 has a total thickness in a range of about 0.4 mm to 1 mm, in particular about 0.6 mm.

As the barrier layer 40 and carbide layer 42 are each built up in one or more layers, multiple laser/nozzle stations may be used to apply each individual layer in sequential fashion. For example, a moving strip 44 of blade body 38 may pass by several laser/nozzle stations where the layers of barrier material and carbide material are applied.

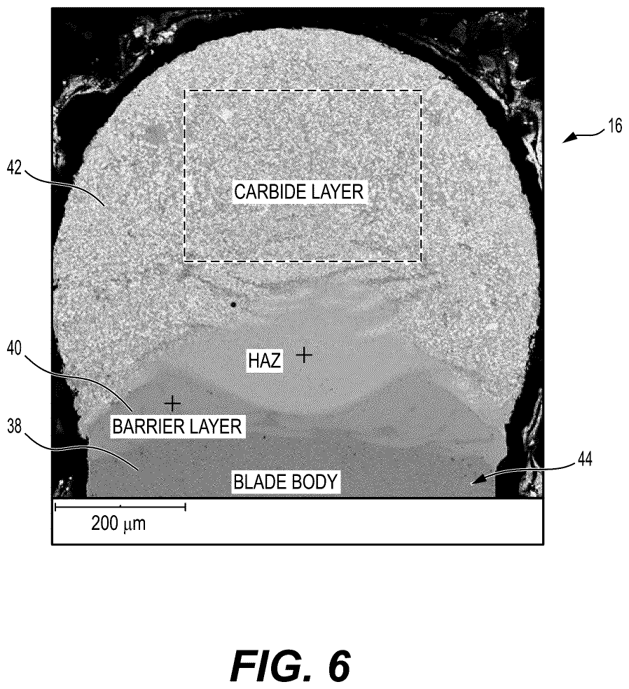

FIG. 6 depicts a micrograph of a cross-section of a strip 44 having the barrier layer 40 and the carbide layer 42 deposited on the strip 44 of blade body 38. As can be seen, the barrier layer 40 provides a continuous separation between the carbide layer 42 and the blade body 38. In particular, the barrier layer 40 separates the carbide layer 42 from the blade body 38 across the thickness of the strip 44 and along the length of the strip 44. As discussed above, the separation provided by the barrier layer 40 prevents diffusion of elements from the blade body 38 into the carbide layer 42, which can cause formation of brittle phases in the carbide layer 42 that may lead to premature failure of the blade 16.

After deposition of the barrier layer 40 and the carbide layer 42, the strip 44 is heat treated in a furnace to refine the carbides and removes porosity and cracks in the carbide layer 42. In one or more embodiments, heat treating involves heating the strip at a rate in a range of 100° C./min to 130° C./min (in particular at about 120° C./min) to a temperature in a range of 1050° C. to 1200° C. (in particular to about 1115° C.), holding at that temperature for a time in a range from 1 minute to about 10 minutes (in particular about 3 minutes), and then air quenching to room temperature. As shown in FIG. 6, the carbide layer 42 after deposition provides a blunt, rounded edge, and thus, after heat treating, the strip 44 is ground to provide a sharp cutting edge 26. Further, the strip 44 may be divided into individual blades 16, such as by cutting or stamping the strip 44.

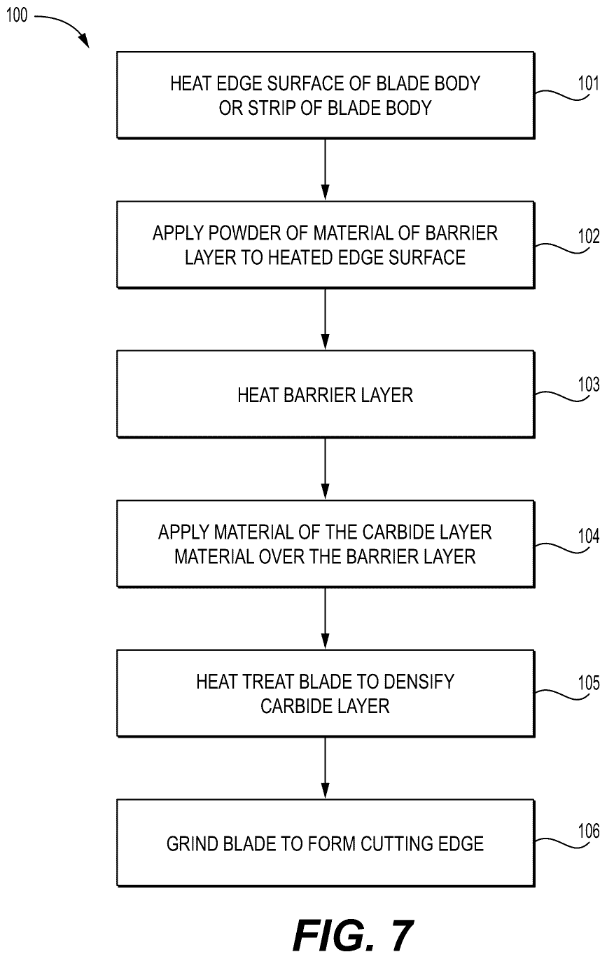

FIG. 7 provides a flow diagram of a method 100 for producing a blade 16 according to the present disclosure. In a first step 101 of the method, the edge surface 50 of a blade body 38 or a strip of blade body 38 is heated, in particular to a molten state. As depicted in FIG. 4, heating may be accomplished using a laser, but other means of heating the edge surface 50 are also possible, such electron beam, induction heating, and plasma arc, among others. After the edge surface 50 is heated, a powder of the material of the barrier layer 40 is applied to the edge surface 50 in a second step 102 to form the barrier layer 40. As shown in FIG. 4, the heating (step 101) and applying (step 102) may be performed substantially simultaneously. In a third step 103, the barrier layer 40 is heated, and in a fourth step 104, the carbide layer 42 is applied over the barrier layer 40. As discussed above, the carbide layer 42 may be applied as either a powders of metal particles and carbon flakes (in which carbides precipitate in the melt pool) or as powders of carbide particles and binder material. As discussed above, the material of the barrier layer 40 and the material of the carbide layer 42 may be applied in multiple layers by multiple passes of the heating device and powder nozzle. Further, the barrier layer 40 and the carbide layer 42 may be applied on the blade 16 or strip 44 by passing the blade 16 or strip 44 under multiple stations of the heating device and powder nozzle, each station configured to provide the desired mix of powders to form the barrier layer 40 and the carbide layer 42. In a fifth step 105, the blade 16 or strip 44 is heat treated, and in a sixth step 106, the blade 16 or strip 44 is ground to form the cutting edge 26.

In the blade 16 according to the present disclosure and produced according to the disclosed process, the barrier layer 40 will generally have the lowest hardness, and the carbide layer 42 will have the highest hardness. The material of the blade body 38 will generally have a hardness between that of the barrier layer 40 and the carbide layer 42. Further, the material of the blade body 38, especially when the material is a steel alloy, may have a gradient of hardness as a result of hardening caused by the heat-affected zone in the blade body 38 during heating of the edge surface 50 and barrier layer 40 while applying the barrier layer 40 and the carbide layer 42.

The barrier layer 40 will remelt during application of the carbide layer 42, but the material of the barrier layer 40 may be selected such that it does not harden during such remelting and cooling. Instead, the barrier layer 40 may soften because the remelting may homogenize the barrier layer 40. Notwithstanding, some minor diffusion between the blade body 38 and the barrier layer 40 and between the barrier layer 40 and the carbide layer 42 may take place that may increase the hardness of the barrier layer 40 at the interfaces with the blade body 38 and carbide layer 42, respectively.

After heat-treatment, in one or more embodiments, the blade body 38 has a hardness in a range of 600 HV to 700 HV in a region adjacent to the barrier layer 40, the barrier layer 40 has hardness in a range from 400 HV to 550 HV, and the carbide layer 42 has a hardness in a range from 800 HV to 1500 HV.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

What is claimed is:

1. A blade, comprising:
a blade body comprising a first material having a primary elemental constituent;
a barrier layer disposed on the blade body, the barrier layer comprising a second material that does not contain the primary elemental constituent of the first material;
a carbide layer disposed on the barrier layer, the carbide layer comprising a carbide material and a binder material and the carbide layer forming a cutting edge of the blade;
wherein the barrier layer provides continuous separation between the blade body and the carbide layer.

2. The blade of claim 1, wherein the carbide material comprises at least one of tungsten carbide, chromium carbide, titanium carbide, tantalum carbide, or niobium carbide.

3. The blade of claim 1, wherein the binder material comprises at least one of nickel, cobalt, chromium, iron, or molybdenum.

4. The blade of claim 1, wherein the carbide layer comprises from 25 wt % to 95 wt % of carbide material and from 5 wt % to 75 wt % of binder material.

5. The blade of claim 1, wherein the first material comprises a steel alloy and wherein the barrier layer comprises a cobalt alloy.

6. The blade of claim 1, wherein the carbide layer is harder than the blade body and the blade body is harder than the barrier layer.

7. The blade of claim 1, wherein the carbide layer has a hardness in a range from 800 HV to 1500 HV.

8. The blade of claim 1, wherein the carbide layer comprises about 16.5 wt % tungsten, about 15.5 wt % chromium, about 4 wt % silicon, about 3.5 wt % iron, about 2.9 wt % boron, about 2 wt % carbon, and a balance of nickel.

9. The blade of claim 1, comprising a first edge, a second edge, a first surface, and a second surface, the cutting edge being the first edge and the second edge being on an opposite side of the blade from the first edge, wherein the first surface and the second surface each extend from the first edge to the second edge, the second surface being opposite to the first surface, and wherein the first surface and the second surface define a maximum thickness of the blade, the maximum thickness being 2 mm or less.

10. The blade of claim 9, wherein the second edge comprises one or more notches configured to engage a blade holder of a utility knife.

11. The blade of claim 1, wherein the carbide layer has a thickness in a range from 0.4 mm to 1 mm.

12. A method of forming a blade, comprising:
heating an edge surface of a strip of a blade body;
applying a first powder onto the heated edge surface of the strip to form a barrier layer;
heating the barrier layer;
applying a second powder onto the heated barrier layer to form a carbide layer;
wherein the barrier layer continuously separates the carbide layer from the strip of the blade body; and
wherein the blade body comprises a first material having a primary elemental constituent and the barrier layer comprises a second material that does not contain the primary elemental constituent of the first material.

13. The method of claim 12, wherein applying the second powder comprises applying first particles of one or more metals or alloys and applying second particles of carbon and wherein the method further comprises:
precipitating carbide particles in a melt pool formed during heating of the barrier layer.

14. The method of claim 12, wherein applying the second powder comprises applying a combination of carbide particles and binder particles.

15. The method of claim 12, wherein applying the second powder comprises applying the second powder in a plurality of layers each having a thickness in a range from 0.1 mm to 0.2 mm to provide a carbide layer with a total thickness in a range from 0.4 mm to 1 mm.

16. The method of claim 12, further comprising the step of heat treating the strip of the blade body after applying the second powder.

17. The method of claim 16, wherein heat treating comprises:
heating the strip at a rate in a range from 100° C./min to 130° C./min to a temperature in the range of 1050° C. to 1115° C.;
holding at the temperature for a time in a range from 1 minute to 10 minutes; and
air quenching to room temperature.

18. The method of claim 16, wherein after heat treating the carbide layer has a hardness in a range from 800 HV to 1500 HV.

19. The method of claim 12, further comprising the step of grinding the carbide layer to form a cutting edge of the blade.

20. The method of claim 12, wherein, during the heating of the barrier layer and applying of the second powder, the first material of the blade body is not able to diffuse into the carbide layer.
